(19) United States
(12) Patent Application Publication
(10) Pub. No.: US 2025/0373423 A1
(43) Pub. Date: Dec. 4, 2025

(54) SYSTEMS AND METHODS FOR CONTROLLING ACCESS TO DATA ON ELECTRONIC DOCUMENTS USING VAULTLESS TOKENIZATION

(71) Applicant: Stripe, Inc., South San Francisco, CA (US)

(72) Inventors: Nicholas John MEVES, South San Francisco, CA (US); Jack Martin ROCHE, South San Francisco, CA (US)

(21) Appl. No.: 18/679,363

(22) Filed: May 30, 2024

(51) Int. Cl. H04L 9/08; G06F 21/62

(52) U.S. Cl. CPC H04L 9/088; G06F 21/6209

(57) ABSTRACT

Presented herein are systems and methods of controlling access to values in electronic documents. A first service may receive an electronic document comprising a corresponding plurality of values associated with a corresponding plurality of fields to be provided to at least one of a plurality of client devices. The first service may identify, from the electronic document, a field of the plurality of fields associated with a corresponding value of the plurality of values is to be encrypted. The first service may select, from a plurality of first encryption keys, a first encryption key based on a field type of the field. The first service may generate a token using the value and the first encryption key for the field. The first service may send to a client device of the plurality of client devices, the electronic document comprising the token replacing the value associated with the corresponding field.

### TECHNICAL FIELD

The present application is generally related to systems and methods of controlling and providing access to encrypted data using tokenization.

### BACKGROUND

In a computer networked environment, a first computing device may send data to a second computing device. The data may contain elements that are sensitive or confidential and other elements that are non-sensitive or non-confidential. The sensitive or confidential data elements may be intended to be revealed to certain recipients (e.g., associated with the first or second computing devices) and hidden from other recipients (e.g., associated with other computing devices). Prior to the communication of the data, the first computing device may share a secret with the second computing device to facilitate recovery of encrypted data. As the data is transmitted, the first computing device may apply encryption to the sensitive or confidential data elements and replace these data elements with encrypted values. With the receipt of the data, the second computing device may use the shared secret to decrypt the encrypted data and recover the original data element. While this framework facilitates secure communications between the first computing device and the second computing device, any leakage of the shared secret may result in anyone with the secret to access the encrypted data. Furthermore, this encryption method may be unable to discriminate among the recipients of the data, restricting flexibility and granularity as to which recipients are able to decrypt and access the sensitive or confidential data.

### SUMMARY

Presented herein are systems and methods to control access to values in electronic documents. An electronic document may include a set of corresponding values to be accessed by a multitude of client devices. The electronic document may be, for example, a text file (e.g., Word document) or stored on a database accessed and edited by a group of users associated with the client devices. Each value may correspond to a field defining a data type for the associated value. Each value may include data in accordance with the data type for the associated field. In the electronic document, certain fields and values may correspond to sensitive or confidential data that are to be fully or partially accessible to certain client devices and hidden from other client devices.

One approach to controlling access to various fields and values in the electronic document may be to use vault-based tokenization. Under this approach, a service may generate a respective token for each value of a field identified as containing sensitive or confidential data. The token may be generated using a shared secret (e.g., a symmetric encryption key) from another device or to be communicated with other devices in the network. Once generated, the service may replace or substitute the original data in the value with the respective token and may provide the electronic document with the substitute tokens to one or more of the client devices. In conjunction, the service may store the tokens as associated with the values identified as sensitive or confidential in a data storage (sometimes herein referred to as a vault) to facilitate recovery of the original data in the electronic document. When a request to recover the original data replaced by the token is sent by the client device, the service can determine whether the client device is permitted access. If the client device is determined to be allowed access, the service may access the data storage to retrieve the value associated with the token and return the original value to the client device.

Although this approach may permit for controlled access to the encrypted values in electronic documents, the reliance on the data storage to store the created tokens may result in excessive consumption of computing resources (e.g., processing and memory) and latency. The latency may, in turn, lead to delayed receipt of the encrypted electronic document and by extension accessibility from the perspective of the client device in retrieving the original value, thereby degrading the quality of human-computer interactions (HCI) between the user and the electronic document. In addition, the service may be encumbered by maintaining the data storage containing the associations between the original values and tokens. Furthermore, any communication of the shared secret may lead to the token being accessible by potentially unauthorized entities, exposing the data to exfiltration and the client device to security vulnerabilities.

To address these and other technical problems, a set of services may perform tokenization of sensitive or confidential data in electronic documents without the reliance on data storages (also sometimes herein referred to as a vault) to store and keep associations of tokens and original values. To that end, an encryption and decryption services may use hybrid encryption to encrypt and decrypt sensitive or confidential data in electronic documents. The decryption service may generate a pair of public and private encryption keys for each datatype identified as sensitive or confidential in the electronic document. Upon generation, the decryption service may share the set of public encryption keys with the encryption service while maintaining the set of private encryption keys. The sharing of the public encryption keys may facilitate hybrid public key encryption (HPKE) of data among the services. The decryption service may also maintain a policy specifying which users have access to decrypt and read from specified field types in electronic documents.

For a given electronic document, the encryption service may identify each field with sensitive or confidential data and may select a corresponding public encryption key for the field type of each field. With the selection, the encryption service may generate a token using the public encryption key and the value of the field. The token may include a set of alphanumeric characters, a first portion of which may indicate the set of characters is a token as well as the type of data of the corresponding field, and a second portion of which may include an encrypted form of the original value. The first portion (also referred herein as additional associated data (AAD)) may also indicate that a private key is to be used to decrypt the token, and to ensure or prevent tampering of the overall token. The encryption service may substitute the original value with the token in the electronic document and may transmit the now-encrypted electronic document to the client device. With receipt, the client device may present the encrypted electronic document with an indicator (e.g., text “protected”) in place of the tokens. To recover the original values, a user of the client device may interact with the indicator on the electronic document to send a request to the decryption service. The request may include an identifier of the user as well as the token.

Upon receipt of the request, the decryption service may identify user access permissions from the policy for the user as identified in the request. If the policy indicates that the user is allowed full access to the field associated with the value, the decryption service may select the private encryption key using the token (e.g., the first portion) in the request. With the selection of the key, the decryption service may recover the original value by applying the private encryption key on the token and provide and provide the original value to the client device. If the policy indicates that the user is allowed partial access, the decryption service may recover a portion of the original value (e.g., by performing pseudonymizing or format preserving encryption to partially obfuscate or leave out the remainder), and may provide the portion to the client device. If the policy indicates that the user is allowed no access, the decryption service may provide an indication that the user is denied access to the value for the corresponding token. When the client device is provided at least a portion of the value, the client device may replace the token with the entire or portion of the value on the electronic document. Otherwise, the client device may display the indication that the user is not permitted to access the value.

In this manner, the encryption and decryption services may provide granular control over which client devices are permitted to access the values of the electronic document, without the reliance of a data storage to maintain associations between tokens and corresponding original values. The generation of the tokens in the described manner may result in a significant reduction in latency (e.g., from 300 μs to 1 μs) compared to other techniques for encryption, thereby saving computing resources (e.g., processor and memory). In addition, the lack of storage of tokens onto the data storage may yield additional efficiencies and reductions in latency (relative to approaches that rely on storage of tokens onto such storages (e.g., vaulted approaches entailing 10-50 ms of time), resulting in almost 10,000 times increased speed). The reduction in latency may also improve the quality of HCI between the user of the client device and the electronic document. Furthermore, the lack of the data storage for the tokens may lower the overhead arising from the maintaining such a data storage, all the while providing the ability to encrypt the value with a token and recover the original value from the token and thus maintain security over sensitive and confidential data.

Aspects of the present disclosure may be directed to systems and methods of controlling access to values in electronic documents. A first service may receive an electronic document comprising a plurality of values associated with a plurality of fields to be provided to at least one of a plurality of client devices. The first service may identify, from the electronic document, a field of the plurality of fields associated with a corresponding value of the plurality of values is to be encrypted. The first service may maintain, on a database, a plurality of first encryption keys associated with a plurality of field types. The first service may select, from the plurality of first encryption keys, a first encryption key based on a field type of the field. The first service may generate a token using the value and the first encryption key for the field. The first encryption key may be associated with a second encryption key on a second service to control access to the value. The first service may send to a client device of the plurality of client devices, the electronic document comprising the token replacing the value associated with the corresponding field. The client device may transmit a request comprising a user identifier and the token to the second service to determine whether to recover the value.

In one embodiment, the first service may receive, from the second service, the plurality of first encryption keys associated with the plurality of field types to encrypt values in electronic documents. In another embodiment, the first service may identify, from the electronic document, a second field of the plurality of fields associated with a corresponding second value of the plurality of values that is not to be encrypted. The first service may maintain the corresponding second value associated with the second field in the electronic document.

In yet another embodiment, the first service may remove storage of the token from the first service, responsive to sending the electronic document to the client device. In yet another embodiment, the first service may identify the field as associated with sensitive information to be encrypted from the electronic document. In yet another embodiment, the first service may generate the token to include (i) a first portion identifying the first key used to generate the token and (ii) a second portion identifying the field type of the field associated with the value. In yet another embodiment, the first service may send the electronic document to cause an application on the client device to display the electronic document, including an indication of the value associated with the corresponding field as encrypted.

Aspects of the present disclosure may be directed to systems and methods of providing access to values in electronic documents. A first service may receive from a client device of a plurality of client devices a request identifying (i) a user identifier associated with the client device and (ii) a token associated with a field of a plurality of fields in an electronic document. The token may be included by a second service into the electronic document using a first encryption key associated with a field type of a plurality of field types for the field. The first service may identify, from the plurality of field types, the field type of the field based on at least a portion of the token. The first service may determine that the client device is permitted to access a value associated with the token based on the user identifier and the field type in accordance with a policy. The policy may identify respective permission for each of the plurality of client devices to access the plurality of field types. The first service may generate the value using a second encryption key for the field type, the second encryption key associated with the first encryption key on the second service. The first service may send, to the client device, the value to replace the token in the electronic document. The client device may present the electronic document with the token replacing the token.

In one embodiment, the first service may determine that the client device is restricted from access to the value generated from the token based on the user identifier. The first service may send, to the client device, an indication that the value associated with the token is restricted from provision. In another embodiment, the first service may determine that the client device is permitted partial access to the value associated with the token based on the user identifier. The first service may send a portion of the value to partially replace the token in the electronic document.

In yet another embodiment, the first service may access a database to retrieve a plurality of second encryption keys associated with the plurality of field types to decrypt tokens in electronic documents. The first service may select, from the plurality of second encryption keys, the second encryption key to generate the value based on the field type identified by the token. In yet another embodiment, the first service may generate a first plurality of encryption keys and a corresponding second plurality of encryption keys for the plurality of field types in electronic documents. The first service may provide the second service access to the first plurality of keys for encrypting values of the corresponding plurality of field types in electronic documents.

In yet another embodiment, the first service may receive the request to recover the value, responsive to an application on the client device detecting an interaction with the token on the electronic document. In yet another embodiment, the first service may send the value to cause an application on the client device to (i) remove an indication of the value associated with the corresponding field as encrypted and (ii) display the value instead of the token on the electronic document.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate embodiments of the subject matter disclosed herein.

FIG. 1 illustrates a block diagram of a system for controlling access to data in electronic documents, in accordance with an embodiment.

FIG. 2 illustrates a block diagram of a system for encrypting values in electronic documents, in accordance with an illustrative embodiment.

FIG. 3 illustrates a block diagram of a system for decrypting values in electronic documents, in accordance with an illustrative embodiment.

FIG. 4 illustrates a block diagram of an environment of tokenization for logging in a vault-less tokenization system, in accordance with an illustrative embodiment.

FIG. 5 illustrates a block diagram of a process for controlling access on a user-basis in a vault-less tokenization system, in accordance with an illustrative embodiment.

FIGS. 6A-C illustrate a set of screenshots of user interfaces presenting an electronic document with protection over sensitive or confidential fields, in accordance with an illustrative embodiment.

FIG. 7 illustrates a flow diagram of a method of controlling access to data in electronic documents, in accordance with an illustrative embodiment.

FIG. 8 illustrates a flow diagram of a method of providing access to data in electronic documents, in accordance with an illustrative embodiment.

FIG. 9 illustrates a component diagram of an example computing system suitable for use in the various implementations described herein, in accordance with an embodiment.

### DETAILED DESCRIPTION

Reference will now be made to the illustrative embodiments illustrated in the drawings, and specific language will be used here to describe the same. Nevertheless, it will be understood that no limitation of the scope of the claims or this disclosure is intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is described here in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

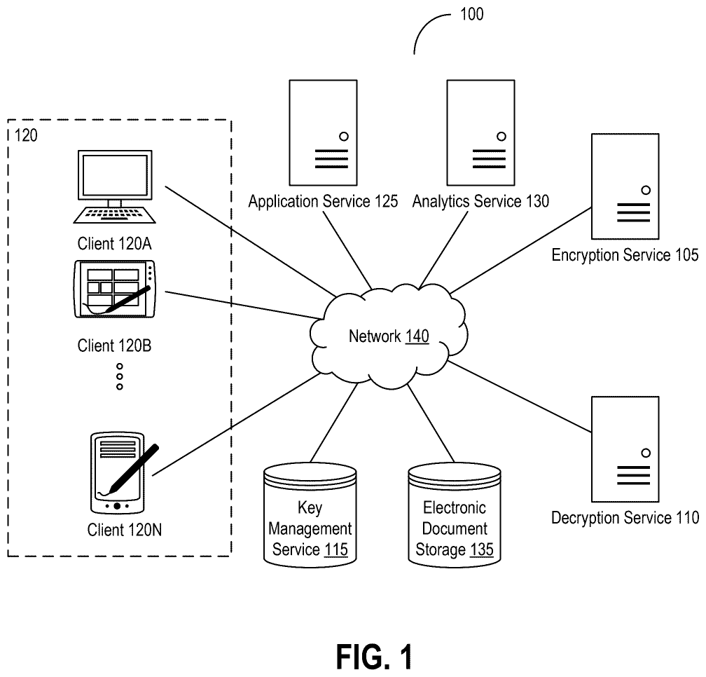

FIG. 1 illustrates a block diagram of a system 100 for controlling access to data in electronic documents. The system 100 may include encryption service 105, at least one decryption service 110, at least one key management service 115, one or more client devices 120A-N (hereinafter generally referred to as client devices 120), at least one application service 125, at least one analytics server 130, and at least one electronic document storage 135, among others, communicatively coupled with one another via at least one network 140. In some embodiments, the encryption service 105 and the decryption service 110 may be part of a same service. In some embodiments, the encryption service 105 and the decryption service 110 may be separate services (e.g., as shown). For example, the application service 125 and the encryption service 105 may be part of the same service. In another example, the application service 125, the encryption service 105, and the decryption service 110 may all be part of the same example.

The encryption service 105 may be any computing device comprising of a processor and non-transitory, machine-readable storage capable of executing the various tasks and processes described herein. The encryption service 105 may be associated with any entity with access to encryption keys (e.g., public encryption keys) to substitute sensitive or confidential data in electronic documents. The encryption service 105 may be in communication with the decryption service 110, the key management service 115, the client devices 120, the application service 125, the analytics server 130, and the electronic document storage 135, among others, via the network 140. In some embodiments, the encryption service 105 may be situated, located, or otherwise associated with at least one server group. Each server group may correspond to a data center, a branch office, or a site at which a subset of servers is situated or associated. In some embodiments, the encryption service 105 may be a cloud storage service provider corresponding to a distributed group of servers on a cloud network.

The decryption service 110 may be any computing device comprising of a processor and non-transitory, machine-readable storage capable of executing the various tasks and processes described herein. The decryption service 110 may, for example, recover original data from tokens in electronic documents using encryption keys. The decryption service 110 may be in communication with the encryption service 105, the key management service 115, the client devices 120, the application service 125, the analytics server 130, and the electronic document storage 135, among others, via the network 140. In some embodiments, the decryption service 110 may be situated, located, or otherwise associated with at least one server group. Each server group may correspond to a data center, a branch office, or a site at which a subset of servers is situated or associated. In some embodiments, the decryption service 110 may be a cloud storage service provider corresponding to a distributed group of servers on a cloud network. In some embodiments, the encryption service 105 may be separate from the decryption service 110. In some embodiments, the encryption service 105 and the decryption service 110 may be part of the same device or servers.

The key management service 115 may store and maintain data for facilitating encryption and decryption of sensitive or confidential data in electronic documents. For instance, the key management service 115 may store encryption keys accessible by the encryption service 105 to generate tokens for sensitive or confidential data. The database may be in communication with the encryption service 105, the decryption service 110, the client devices 120, the application service 125, and the analytics server 130, among others, via the network 140. In some embodiments, the key management service 115 may include a database management system (DBMS) to arrange and organize the data maintained across the databases. The key management service 115 may lack any tokens for encrypting data in electronic documents.

The client device 120 may be any computing device comprising of a processor and a non-transitory, machine-readable storage medium capable of performing the various tasks and processes described herein. Non-limiting examples of the client device 120 may be a workstation computer, laptop computer, phone, tablet computer, or server computer. During operation, various users may use one or more of the client devices 120 to access the platform operationally managed by the encryption service 105, the decryption service 110, and the analytics server 130, among others. Even though referred herein as “user” devices, these devices may not always be operated by users. A client device 120 may be another computing system that automatically transmits information requests to the analytics server without any user input.

The application service 125 may be any computing device comprising of a processor and non-transitory, machine-readable storage capable of executing the various tasks and processes described herein. The application service 125 may facilitate, host, or otherwise maintain resources for an application accessible by clients 120. The application service 125 may, for example, be used to access, read, create, or otherwise modify electronic documents. The application service 125 may be in communication with the encryption service 105, the database, the client devices 120, the analytics server 130, and the electronic document storage 135, among others, via the network 140. In some embodiments, the application service 125 may be situated, located, or otherwise associated with at least one server group. Each server group may correspond to a data center, a branch office, or a site at which a subset of servers is situated or associated. In some embodiments, the application service 125 may be a cloud storage service provider corresponding to a distributed group of servers on a cloud network.

The electronic document storage 135 may store and maintain electronic documents and data associated with the electronic documents. The electronic document storage 135 may be in communication with the encryption service 105, the decryption service 110, the client devices 120, the application service 125, and the analytics server 130, among others, via the network 140. In some embodiments, the electronic document storage 135 may include a database management system (DBMS) to arrange and organize the data maintained across the databases. During the operations, the electronic document storage 135 may store and maintain electronic documents accessed by the client 120 or the application service 125.

The analytics server 130 may utilize features described herein to retrieve data and generate/display results, such as via a platform displayed on various devices. The analytics server 130 may be communicatively coupled to the encryption service 105, the decryption service 110, and the client devices 120, and the application service 125, via the network 140. The analytics server 130 can receive information requests (e.g., information queries or requests for information) from the client devices 120. The analytics server can iteratively execute computer models and applications to generate data queries to query the data sources to generate results in response to the information requests. The system 100 is not confined to the components described herein and may include additional or other components not shown for brevity, which are to be considered within the scope of the embodiments described herein.

The analytics server 130 may generate and display an electronic platform (e.g., an information generation platform that is sometimes referred to as a platform) on any device discussed herein. The platform may be configured to receive requests for recommendations of fault simulations to run on a network infrastructure and automatically output sets of faults in response to such requests. For instance, the electronic platform may include one or more graphical user interfaces (GUIs) displayed on the client device 120. An example of the platform generated and hosted by the analytics server 130 may be a web-based application or a website configured to be displayed on various electronic devices, such as mobile devices, tablets, personal computers, and the like. The platform may include various input elements configured to receive information requests from any of the users and display results in response to such information requests during the execution of the methods discussed herein. The analytics server 130 may iteratively execute the applications to process and generate responses to the information requests.

The analytics server 130 may be any computing device comprising of a processor and non-transitory, machine-readable storage capable of executing the various tasks and processes described herein. The analytics server 130 may employ various processors, such as a central processing unit (CPU) and graphics processing unit (GPU), among others. Non-limiting examples of such computing devices may include workstation computers, laptop computers, server computers, and the like. While the system 100 includes a single analytics server 130, the analytics server 130 may include any number of computing devices operating in a distributed computing environment, such as a cloud environment. The analytics server 130 may be in communication with the encryption service 105, the decryption service 110, and the client devices 120, among others, via the network 140.

The above-mentioned components may be connected to each other through a network 140. The examples of the network 140 may include, but are not limited to, private or public LAN, WLAN, MAN, WAN, and the Internet. The network 140 may include both wired and wireless communications according to one or more standards and/or via one or more transport mediums. The communication over the network 140 may be performed in accordance with various communication protocols such as Transmission Control Protocol and Internet Protocol (TCP/IP), User Datagram Protocol (UDP), and IEEE communication protocols. In one example, the network 140 may include wireless communications according to Bluetooth specification sets or another standard or proprietary wireless communication protocol. In another example, the network 140 may also include communications over a cellular network, including, e.g., a GSM (Global System for Mobile Communications), CDMA (Code Division Multiple Access), and/or EDGE (Enhanced Data for Global Evolution) network.

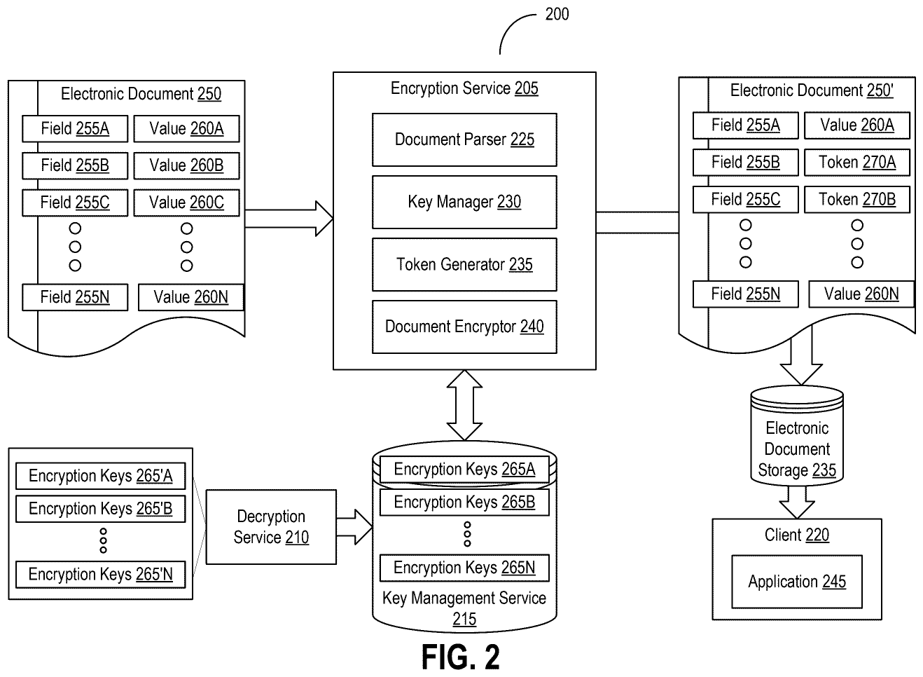

FIG. 2 illustrates a block diagram of a system 200 for encrypting values in electronic documents. In overview, the system 200 may include at least one encryption service 205, at least one decryption service 210, at least one key management service 215, and at least one client device 220, among others. The encryption service 205 may include at least one document parser 225, at least one key manager 230, at least one token generator 235, and at least one document encryptor 240, among others. The client device 220 may include at least one application, 245, among others. Embodiments may comprise additional or alternative components or omit certain components from those of FIG. 2 and still fall within the scope of this disclosure. Various hardware and software components of one or more public or private networks may interconnect the various components of the system 200. Each component in system 200 may be any computing device comprising one or more processors coupled with memory and software and capable of performing the various processes and tasks described herein.

The document parser 225 on the encryption service 205 retrieves, identifies, or otherwise receives at least one electronic document 250 to be provided to one or more clients devices. The electronic document 250 may be, for example, any file in a digital format, such as a relational database file (e.g., SQL, DB, or LOG formats), a document database file (e.g., BSON, JSON, XML, or YAML formats), a structured data format file (e.g., CSV, TSV, XLS, or XML formats), an unstructured format file (e.g., TXT file format), a text document (e.g., DOC, or DOCX formats), a spreadsheet (e.g., XLS, XLSX formats), a script (e.g., HTML, or JavaScript format), or an electronic mail (e.g., EML or PST), among others. The electronic document 250 may be received by the document parser 225. The electronic document 250 may be received by the encryption service 205 from one of the client devices 220 or another data source via a network.

The electronic document 250 may identify, contain, or otherwise include a set of values 260A-N (hereinafter generally referred to as values 260), among others. The set of values 260 may be associated with a corresponding set of fields 255A-N (hereinafter generally related to fields 255). Each field 255 (sometimes herein referred to as a key, a data type, or attribute) may be associated with a corresponding value 260. Each field 255 may define or identify a field type (or data type) for the associated value 260. Conversely, each value 260 may be associated with the corresponding field 255. Each value 260 may include or identify data for the corresponding field 255. For example, for the field 255 for electronic mail addresses, the corresponding value 260 may include an electronic mail address itself. In some embodiments, the electronic document 250 may be unstructured. For example, the electronic document 250 may contain or include the set of values 260 themselves without any predefined structure labeled in the electronic document 250 itself, and the fields 255 may be identified from processing or parsing the electronic document 250. In some embodiments, the electronic document 250 may be structured. The set of fields 255 and the corresponding set of values 260 may be in accordance with structure for the electronic document 250. The structure may specify or define a syntax or layout of a set of fields 255 and the corresponding set of values 260 for the electronic document 250.

From the electronic document 250, the document parser 225 determine, selects, or otherwise identifies at least one field 255 from the set of fields 255 associated with a corresponding value 260 to be encrypted. In some embodiments, the document parser 225 may identify or determine whether the electronic document 250 is unstructured or structured. The determination may be based on a file type (e.g., identified from file extension) of the electronic document 250. When the electronic document 250 is identified as unstructured, the document parser 225 may identify the set of fields 255 from the set of values 260. In some embodiments, the document parser 225 may use a natural language processing (NLP) algorithm to identify the fields 255. The NLP algorithm may include, for example, a named entity recognition (NER), information extraction (IE), semantic parsing, or regular expression, among others. Conversely, when the electronic document 250 is identified as structured, the document parser 225 may identify the set of fields 255 in accordance with the structure for the electronic document 250. For instance, the document parser 225 may parse the structure specifying the correspondences between fields 255 and values 260 for the electronic document 250. For each value 260, the document parser 225 may identify the associated field 255 using the structure.

For each field 255, the document parser 225 may determine or identify whether the field 255 associated with a corresponding value 260 is to be encrypted or decrypted. The identification may be based on whether the field type of the field 255 is associated with sensitive or confidential information that is to be encrypted. In some embodiments, the document parser 225 may identify the field 255 as associated with sensitive or confidential information that is to be encrypted based on the field type or data type. In some embodiments, the document parser 225 may identify the field 255 as associated with sensitive or confidential information. The sensitive or confidential information may include, for example, personally identifiable information (PII) (e.g., full names, date of birth, contact information, or identification number), financial data (e.g., credit card number, bank account number, or transaction record), or health information (e.g., medical history, insurance information, or prescriptions), among others. The definitions for sensitive or confidential information may be configured by an administrator of the encryption service 205 (or the decryption service 210).

When the field type of the field 255 is associated with sensitive or confidential, the document parser 225 may identify that the field 255 associated with the corresponding value 260 is to be encrypted. The document parser 225 may also select, or otherwise identify the value 260 as to be encrypted from the electronic document 250. Otherwise, when the field type of the field 255 is not associated with sensitive or confidential, the document parser 225 may identify that the field 255 associated with the corresponding value 260 is not to be encrypted. The document parser 225 may keep or maintain the value 260 associated with the field 255 in the electronic document 250. The document parser 225 may parse and search through the electronic document 250 for the set of fields 255 and the set of values 260 (e.g., as detailed herein). The document parser 225 may repeat the identification of whether each field 255 is to be encrypted.

In conjunction, the key manager 230 on the encryption service 205 maintains a set of encryption keys 265A-N (hereinafter generally referred to as encryption keys 265) associated with a corresponding set of field types for the set of fields 255 on the key management service 215. The key manager 230 may retrieve, identify, or receive the set of encryption keys 265 from the decryption service 210. The decryption service 210 may produce, create, or otherwise generate the set of encryption keys 265 and a corresponding set of encryption keys 265′A-N (hereinafter generally referred to as encryption keys 265′). The generation of the set of encryption keys 265 and 265′ may be in accordance with an asymmetric encryption algorithm, such as a Rivest-Sharmir-Adleman (RSA), a Diffic-Hellman Key Exchange, Elliptic Curve Cryptography (ECC), or Digital Signature Algorithm, among others. For instance, the set of encryption keys 265 may correspond to public encryption keys, whereas the set of encryption keys 265′ may correspond to private encryption keys. Each encryption key 265 may be associated with a corresponding encryption key 265′ for each respective field type. For example, there may be one pair of encryption keys 265 and 265′ for encrypting and decrypting electronic mail addresses, and another pair of encryption keys 265 and 265′ for encrypting and decrypting social security numbers.

With the generation, the decryption service 210 may provide the encryption service 205 access to the set of encryption keys 265, without providing access to the set of encryption keys 265′. In some embodiments, the decryption service 210 may store and maintain the set of encryption keys 265 on the key management service 215, which is accessible to the encryption service 205. The decryption service 210 may store an association between the set of encryption keys 265 and the corresponding set of field types. In some embodiments, the decryption service 210 may provide, transmit, or otherwise send the set of encryption keys 265 to the encryption service 205. The decryption service 210 may also send the association between the set of encryption keys 265 and the corresponding set of field types. The key manager 230 may retrieve, identify, or otherwise receive the set of encryption keys 265 from the decryption service 210 to encrypt values in electronic documents. Upon receipt, the key manager 230 may store and maintain the set of encryption keys 265 on the key management service 215. In some embodiments, the key manager 230 may store and maintain an association between the set of encryption keys 265 and the corresponding set of field types.

For each identified field 255 associated with the value 260 to be encrypted, the key manager 230 identifies or selects at least one encryption key 265 from the set of encryption keys 265 on the key management service 215 based on the field type of the field 255. In some embodiments, the key manager 230 may access the key management service 215 to search, find, or otherwise retrieve the encryption key 265 using the field type of the field 255 associated with the value 260 to be encrypted. The key manager 230 may select the encryption key 265 from the set of encryption keys 265 on the key management service 215 using the associations between encryption keys 265 and the field types. The key manager 230 may repeat the selection of the encryption key 265 across all the fields 255 associated with values 260 identified as to be encrypted. The key manager 230 may refrain from selecting any of the encryption keys 265 for fields 255 associated with values 260 identified as not to be encrypted.

The token generator 235 on the encryption service 205 may produce, determine, or otherwise generate at least one token 270A-N (hereinafter generally referred to as token 270), using the value 260 and the encryption key 265 for each identified field 255. The token 270 may identify or include encrypted data (e.g., a nonce or random set of alphanumeric characters) corresponding to the value 260. The token 270 may be generated in accordance with the asymmetric encryption algorithm (e.g., RSA, ECC, or digital signature algorithm) for the encryption key 265. For example, the token generator 235 may generate the token 270 using a cryptographic hash function (e.g., message digest algorithm (MDA), secure hash algorithm (SHA), or blind indexing) in accordance with the asymmetric encryption algorithm.

In some embodiments, the token generator 235 may generate the token 270 to include at least a first portion, a second portion, and a third portion. The first portion may include an identifier (e.g., a predefined set of alphanumeric characters) referencing which encryption key 265 was used to generate the token 270. In some embodiments, the first portion may also indicate that the value 260 is encrypted. For example, the first portion of the token 270 may serve as additional authenticated data (AAD) to provide authenticity to the token 270 as well as prevent tampering of the token 270. The second portion may identify the field type of the field 255 associated with the value 260. The second portion may include a set of alphanumeric characters for the field type, as defined in mapping between token portions and field types. The third portion may include the encrypted data generated from applying the encryption key 265 to the corresponding value 260. The first, second, and third portions may each correspond to a different subset of alphanumeric characters forming the token 270 and may be contiguous or non-contiguous.

In some embodiments, the token generator 235 may generate the token 270 in accordance with hybrid public key encryption (HPKE). To generate the token 270, the token generator 235 may calculate, determine, or otherwise generate a secret key in accordance with a symmetric encryption algorithm, such as an advanced encryption standard (AES), authenticated encryption (AE), stream cipher, or block cipher, among others. The secret key may be derived or generated from the encryption key 265 using the symmetric encryption algorithm. In some embodiments, the token generator 235 may retrieve, obtain, or identify the secret key previously generated for the field type of the field 255. Using the secret key and the value 260 associated with the field 255, the token generator 235 may produce, determine, or otherwise generate encrypted data. In some embodiments, the token generator 235 may encapsulate the encrypted data by applying the encryption key 265. From encapsulating, the token generator 235 may generate the token 270 to include the secret key and the doubly encrypted data corresponding to the value 260. The secret key may correspond to a fourth portion of the token 270.

The document encryptor 240 on the encryption service 205 may substitute, exchange, or otherwise replace the value 260 with the token 270 for each field 255 associated with the value 260 identified as to be encrypted. For instance, as depicted, the document encryptor 240 may assign or set the data of the values 260B and 260C to the respective tokens 270A and 270B, for the fields 255B and 255C identified as to be encrypted. The document encryptor 240 may repeat the replacement of values 260 with the corresponding tokens 270 in the electronic document 250 to form at least one encrypted electronic document 250′. In some embodiments, the document encryptor 240 may also add, insert, or otherwise include an indication of the value 250 associated with the field 255 identified as encrypted for each token 270 in the electronic document 250′.

With the replacement of the values 260 with the tokens 270, the document encryptor 240 may provide, transmit, or otherwise send the electronic document 250′ to the client device 220. In some embodiments, the document encryptor 270 may send the electronic document 250′ to the client device 220 in response to a request from the client device 220 for the electronic document 250′. In some embodiments, the document encryptor 240 may store and maintain the electronic document 250′ on a database accessible to the client device 220. In some embodiments, upon sending of the electronic document 250′ or otherwise permitting the electronic document 250′ to be accessible to the client device 220, the document encryptor 240 may delete, erase, or otherwise delete the token 270 from storage on the encryption service 205.

The application 245 on the client device 220 may retrieve, identify, or otherwise receive the encrypted electronic document 250′ from the encryption service 205. The application 245 may correspond to or include a program running on the client device 220 to perform one or more operations on the electronic document 250′, such as loading, rendering, editing, deleting, or saving, among others. For example, the application 245 may include a word processor for word document files, a spreadsheet editor for spreadsheet files, a software development kit for script files, an email agent for emails, or a web application through a browser to provide various functionalities (e.g., of the word processor, spreadsheet editor, software development kit, or the email agent) among others. In some embodiments, the application 245 may include at least one component (e.g., a plug-in, an add-on, or extension) to request for recovery of the values 260 from the token 270 included in the electronic document 250′. The component may have been installed or set up within the application 245, separately from the installation of the application 245 on the client device 220. The functionalities described as ascribed to the application 245 may be performed by the component included in the application 245.

Upon receipt of the electronic document 250′ from the encryption service 205, the application 245 may render, present, or otherwise display the electronic document 250′ (e.g., via the graphical user interface of the application 245). When displayed, the electronic document 250′ may include an indication of the value 250 associated with the field 255 identified as encrypted. The indication may include at least one user interface element (e.g., a text object, a button, a form, a check box, a radio box, or an icon) on the electronic document 250′ to request for the value 250 replaced by the token 270. The user interface element may be presented in the foreground of the token 270, thereby obstructing the token 270 from view from the perspective of the user of the application 245. In some embodiments, the application 245 (or the component of the application 245) may parse or process the electronic document 250′ to select or identify the tokens 270. The identification of each token 270 may be based on the inclusion of the indicator that the value 260 is encrypted in the token 270. For each token 270, the application 245 may insert, add, or otherwise include the indication for each token 270 for display on the electronic document 250′.

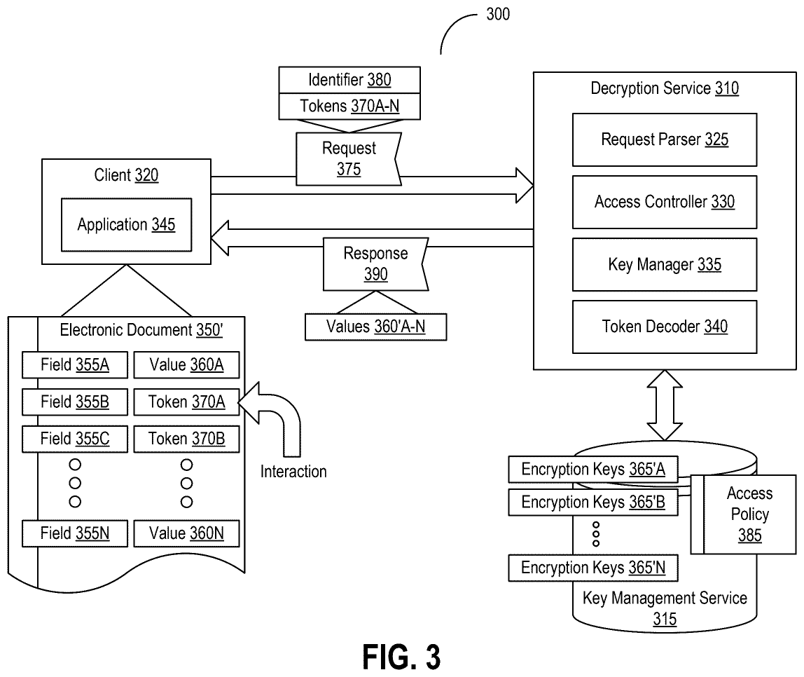

FIG. 3 illustrates a block diagram of a system 300 for decrypting values in electronic documents. The system 300 may include at least one decryption service 310, at least one key management service 315, and at least one client device 320, among others. The decryption service 310 may include at least one request parser 325, at least one access controller 330, at least one key manager 335, and at least one token decoder 340, among others. The client device 320 may include at least one application 345, among others. Embodiments may comprise additional or alternative components or omit certain components from those of FIG. 3 and still fall within the scope of this disclosure. Various hardware and software components of one or more public or private networks may interconnect the various components of the system 300. Each component in system 300 may be any computing device comprising of one or more processors coupled with memory and software and capable of performing the various processes and tasks described herein.

The application 345 on the client device 320 may render, present, or otherwise display at least one electronic document 350′. The electronic document 350′ may identify or include a set of fields 355A-N (hereinafter generally related to fields 355) and a corresponding set of values 360A-N (hereinafter generally related on values 360) or tokens 370A-N (hereinafter generally referred to as tokens 370), among others. Each field 355 (sometimes herein referred to as a key or attribute) may be associated with a corresponding value 360. For at least one of the fields 355, the corresponding value 360 may have been substituted or replaced with at least one corresponding token 370. The token 370 may be generated and included by an encryption service into the electronic document 350′ using an encryption key associated with a field type of the associated field 355. The corresponding value 360 replaced by the token 370 may have absent or lacking from the electronic document 350′. In the depicted example, the electronic document 350′ may have fields 355B and 355C with values 360B and 360C replaced with tokens 370B and 370C. The values 360B and 360C may not be initially included or present in the electronic document 350′ provided to the client device 320. In some embodiments, the application 345 (or a component of the application 345) may insert, add, or otherwise include an indicator for each token 370 for display on the electronic document 350′. The indication may include at least one user interface clement (e.g., a text object, a button, a form, a check box, a radio box, or icon) on the electronic document 250 to request for the value 360 replaced by the token 370 on the electronic document 350′.

The application 345 provides, transmits, or otherwise sends at least one request 375 to retrieve, reconstruct, or otherwise recover values 360 to the decryption service 310. The request 375 may include or identify at least one identifier 380 and one or more tokens 370. The identifier 380 may reference, correspond to, or otherwise be associated with the client device 320 (e.g., device identifier, network address, or session identifier), the application 345 (e.g., application identifier or package name), or the user (e.g., account identifier, email address, or biometric identifier), among others. The application 345 may parse the electronic document 350′ to extract or identify the tokens 370 therein to include into the request 375. Each token 370 may be associated with a corresponding field 355 in the electronic document 350′. In some embodiments, the application 345 may automatically generate the request 375, without triggering from an interaction by the use with the electronic document 350′.

In some embodiments, the application 345 may wait, listen, or otherwise monitor for at least one interaction with one of the tokens 370 (or the indication associated with the token 370). The interaction can include, for example, a mouse click, a screen touch, a key press, a button press, or any trigger of an event listener associated with the token 370 (or the indication) on the electronic document 350′. With the detection of the interaction, the application 345 may select or identify the token 370 associated with the interaction. The application 345 may generate the request 375 to insert or include the identifier 380 and the token 370 associated with the interaction. The request 375 may lack the other tokens 370 on the electronic document 350′. For example, the application 345 may generate the request 375 to include the identifier 380 for the user, as well as the token 370 associated with the button (e.g., an example of the button) that the user interacted with. Upon the generation of the request 375, and application 345 may transmit or send the request 375 to the decryption service 310.

The request parser 325 on the decryption service 310 retrieves, identifies, or otherwise receives the request 375 from the client device 320. In some embodiments, the request parser 325 may receive the request 375, in response to the application 345 on the client device 320 detecting the interaction with the token 370. The request parser 325 may process or parse the request 375 to extract or identify the identifier 380 and the one or more tokens 370. For each identified token 370, the request parser 325 may process or parse the token 370 to extract or identify one or more portions therein. The token 370 has a first portion, a second portion, and a third portion, among others. The first portion may include an identifier referencing which encryption key was used to generate the token 370. In some embodiments, the first portion may include an indicator that the value 360 is encrypted. The second portion may identify the field type of the field 355 associated with the value 360. The third portion may include the encrypted data generated from applying the encryption key (e.g., a public encryption key available to the encryption service) to the corresponding value 360.

Based on at least a portion (e.g., the second portion) of the token 370, the request parser 325 may determine or identify the field type of the field 355 associated with the token 370. In some embodiments, the request parser 325 may use a mapping between token portions and field types. The mapping may specify or define a relationship between a field type and a respective token portion (e.g., a set of alphanumeric characters for the field type included in tokens. From the mapping, the request parser 325 may search, find, or otherwise identify the field type for the token 370. In some embodiments, the request parser 325 may parse the request 375 to identify a fourth portion corresponding to a secret key used to doubly encrypt the first portion, the second portion, and the third portion, in accordance with hybrid public key encryption (HPKE). In some embodiments, the request parser 325 may perform initial decryption on the doubly encrypted (or encapsulated) portions in accordance with HPKE using the secret key. With the initial decryption, the request parser 325 can parse the token 370 to identify the first, second, and third portions and identify the field type of the field 355 associated with the token 370.

The access controller 330 on the decryption service 310 maintains at least one access policy 385 on the key management service 315 (or on the decryption service 310 itself). The access policy 385 may specify, define, or otherwise identify a permission for each client device (or application or user) to access one or more field types. Each client device (or application or user) may be identified using identifiers (e.g., the identifier 380). For a given field type, the permission may include one of full, partial, or restricted for the client device 320. The permissions may differ among client devices and across various field types. For instance, for a field type defining a date of birth, the access policy 385 may specify that a first client device has full access, a second client device has partial access (e.g., to the year but not date), and a third client device has no access. On a given electronic document (e.g., the electronic document 350), a client device may have access to some values replaced by tokens but not to other values also substituted with tokens. The access policy 385 may be configured or defined by an administrator of the decryption service 310.

With the receipt of the request 375, the access controller 330 identifies or determines whether the client device 320 (or the application 345 or the user) is permitted to access the corresponding value 360 associated with the token 370. The determination may be based on the identifier 380 and the field type for the field 355 in accordance with the access policy 385. Using the identifier 380, the access controller 330 may find, retrieve, or otherwise identify the access permissions for the client device 320 (or the application 345 or user) from the access policy 385. With the identification, the access controller 330 may select or identify the access permission for the client device 320 for the respective field type based on the identified field type associated with each token 370 of the request 375.

When the access policy 385 specifies that the client device 320 has full access to the field type, the access controller 330 may determine that the client device 320 is permitted to recover or access the value 360 associated with the token 370. When the access policy 385 specifies that the client device 320 has partial access to the field type, the access controller 330 may determine that the client device 320 is permitted to partially recover or access a portion of the value 360 associated with the token 370. The access controller 330 may also determine or identify the portion of the value 360 that the client device 320 is permitted to access using the access policy 385. When the access policy 385 specifies that the client device 320 is restricted from accessing the field type, the access controller 330 may determine that the client device 320 is restricted from accessing the value 360 associated with the token 370. The access controller 330 may provide, send, or otherwise transmit an indication that the client device 320 is restricted from accessing the value 360 associated with the token 370 to the client device 320 for presentation via the application 345.

In conjunction, the key manager 335 on the decryption service 310 maintains a set of encryption keys 365′A-N (hereinafter generally referred to as encryption keys 365′) associated with the corresponding set of field types for the set of fields 355 on the key management service 315. The key manager 335 may produce, create, or otherwise generate the set of encryption keys 365′ and a corresponding set of encryption keys. The generation of the set of encryption keys 365 and 365′ may be in accordance an asymmetric encryption algorithm, such as a Rivest-Sharmir-Adleman (RSA), a Diffic-Hellman Key Exchange, Elliptic Curve Cryptography (ECC), or Digital Signature Algorithm, among others. For instance, the set of encryption keys 365′ may correspond to private encryption keys, whereas the set of encryption keys may correspond to public encryption keys. Each encryption key 365′ may be associated with a corresponding encryption key for each respective field type. With the generation, the key manager 335 may provide the encryption service access to the set of encryption keys (e.g., public keys), without providing access to the set of encryption keys 365′. In some embodiment, the key manager 335 may store and maintain the set of encryption keys 365′ on the key management service 315 accessible to the encryption service. The key manager 335 may store an association between the set of encryption keys 265 and the corresponding set of field types. In some embodiments, the key manager 335 may provide, transmit, or otherwise send the set of encryption keys 365′ to the encryption service. The key manager 335 may also send the association between the set of encryption keys 365′ and the corresponding set of field types.

When the client device 320 is determined to be permitted at least partially recover or access the value 360 associated with the token 370, the key manager 335 may identify or select at least one encryption key 365′ from the set of encryption keys 365′ on the key management service 315. The selection may be based on the field type of the field 355 associated with the token 370. In some embodiments, the key manager 335 may access the key management service 315 to search, find, or otherwise retrieve the encryption key 365′ using the field type. The key manager 335 may select the encryption key 365 from the set of encryption keys 365′ on the key management service 315 using the associations between encryption keys 365′ and the field types. The key manager 335 may repeat the selection of the encryption key 365′ across all the field types associated with the token 370 for which the client device 320 is determined to be permitted at least partial access. The key manager 335 may refrain from selecting any of the encryption keys 365′ for field types associated with the token 370 for which the client device 320 is determined to be restricted from access.

The token decoder 340 on the decryption service 310 creates, produces, or otherwise generates at least one value 360′A-N (hereinafter generally referred to as value 360′) using the encryption key 365′ selected for the corresponding token 370. In some embodiments, the token decoder 340 may apply the encryption token 365′ to at least the third portion of the token 370 to decrypt, decode, or otherwise recover the value 360′. The value 360′ may correspond to or may be the same as the value 360 originally in the electronic document 350′. The token decoder 340 may use the same encryption algorithm used to generate at least a portion of the token 370. For instance, the token decoder 340 may generate the value 360′ by applying a cryptographic hash function (e.g., message digest algorithm (MDA), secure hash algorithm (SHA), or blind indexing) on the token 370 in accordance with the asymmetric encryption algorithm (e.g., RSA, ECC, or DSA). The asymmetric encryption algorithm may have been used by the encryption service to generate the token 370.

The token decoder 340 may perform the recovery of the value 360′ from the token 370 if the client device 320 is determined to be permitted at least partial recovery or access to the value 360 associated with the token 370. When the client device 320 is determined to be permitted full recovery or access to the value 360 associated with the token 370, the token decoder 340 may maintain the full value 360′ generated using the encryption key 365′. When the client device 320 is determined to be permitted full recovery or access to the value 360 associated with the token 370, the token decoder 340 may change, alter, or otherwise modify a portion of the value 360′. The modification may be in accordance with the specifications of the access policy 385. For example, for a field type related to social security numbers, the token decoder 340 may hide, mask, or otherwise obscure all but the last three digits of the value 360′ as defined by the access policy 385. The token decoder 340 may repeat the process of recovering each value 360′ for which the client device 320 is determined to have partial access.

The token decoder 340 provides, transmits, or otherwise sends at least one response 390 to the client device 320. When the client device 320 is determined to have full access to recover or access the value 360 associated with the token 370, the token decoder 340 may generate the response 390 to include the value 360′ in full. When the client device 320 is determined to have partial access to recover or access the value 360 associated with the token 370, the token decoder 340 may generate the response 390 to include the portion of the value 360′ (e.g., a modified version of the value 360′). In some embodiments, the response 390 may include or identify a field type for the value 360′ (for partial or full). When the client device 320 is determined to be restricted from access to recover or access the value 360 associated with the token 370, the token decoder 340 may generate the response 390 to include an indication that the client device 320 is restricted from accessing the value 360 associated with the token 370. In some embodiments, the response 390 may include or identify a field type for which the client device 320 is restricted access. In some embodiments, token response 390 may lack any value 360 for which the client device 320 is determined not to have access. With the generation of the response 390, the token decoder 340 may send the response 390 to the client device 320.

The application 345 on the client device 320 may retrieve, identify, or otherwise receive the response 390 from the decryption service 310. With receipt, the application 345 (or the component of the application 345) may process or parse the response 390 to extract or identify the one or more values 360′ or the indication of restricted access for the field type. In some embodiments, the application 345 may identify the field type for each value 360′ from the response 390. For each value 360′ identified from the response 390, the application 345 may select or identify the corresponding field 355 and associated token 370 on the electronic document 350′. The application 345 may exchange, substitute, otherwise replace the corresponding token 370 from the electronic document 350′. In some embodiments, the application 345 may withdraw or remove the indication (e.g., the user interface element for requesting decryption) identifying the corresponding field 355 as encrypted. The application 345 may insert, add, or otherwise include the recovered value 360′ for display on the electronic document 350′, instead of the token 370. For each indication of restricted access, the application 345 may maintain the token 370 (or the indication). In some embodiments, the application 345 may render, present, or otherwise display the indication that the client device 320 (or the application 345 or user) is restricted from accessing the value 360 associated with the token 370.

In this manner, the encryption service may encrypt values that are identified as sensitive or confidential using tokens generated from encryption keys (e.g., public encryption keys), without reliance on a data repository to store the tokens for later use. The decryption service may provide for granular control over which client device are permitted to recover and access the original values as well as recover the values from the tokens, by applying corresponding encryption keys (e.g., private encryption keys). Since the tokens are not stored on the services (e.g., the encryption service or the decryption service), there may be less overhead from maintenance of such data, thereby saving computing resources (e.g., processor and memory) and network bandwidth. In addition, since the encryption service does not invoke and store the tokens onto a data storage, the latency may be significantly reduced r (e.g., from 300 μs to 1 μs). The reduction in latency may also improve the quality of HCI between the user of the client device and the electronic document.

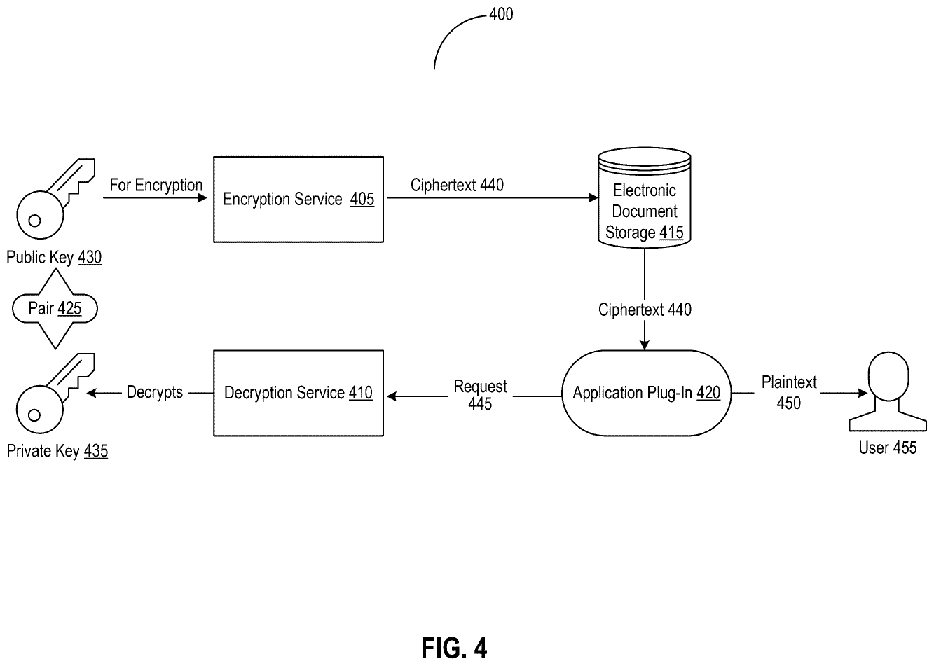

FIG. 4 illustrates a block diagram of a system or an environment 400 for tokenization for logging in a vault-less tokenization system. The system or environment 400 may include at least one encryption service 405, at least one decryption service 410, at least one electronic document storage 415, and at least one application plug-in 420 associated with at least one user 455, among others. Embodiments may comprise additional or alternative components or omit certain components from those of FIG. 4 and still fall within the scope of this disclosure. Various hardware and software components of one or more public or private networks may interconnect the various components of the environment 400. Each component in the environment 400 may be any computing device comprising of one or more processors coupled with memory and software and capable of performing the various processes and tasks described herein.

The decryption service 410 may generate at least one key pair 425 for each attribute type in electronic documents for logging. The key pair 425 may include at least one public key 430 and at least one private key 435. The decryption service 410 may share the public key 430 with the encryption service 405. Using the public key 430, the encryption service 405 may encrypt values of the specified attribute type in an electronic document for logging to generate ciphertext 440 (sometimes herein referred to as a token). With the generation, the encryption service 405 may store the electronic document with the ciphertext 440 on the electronic document storage 415.

The application plug-in 420 may retrieve the electronic document with the ciphertext 440 from the electronic document storage 415. To recover the original value, the user 455 may interact with the application plug-in 420 to send a request 445 to the decryption service 410. The request 445 may include a user identifier and the ciphertext 440 itself. The decryption service 410 may determine whether the user 455 has access to the original value for the ciphertext 440 based on the attribute type. If the user 455 is determined to have access, the decryption service 410 may decrypt the ciphertext 440 using the private key 435 to recover the original plaintext 450. The decryption service 410 may return and send the original plaintext 450 to the application plug-in 420 for presentation to the user 455.

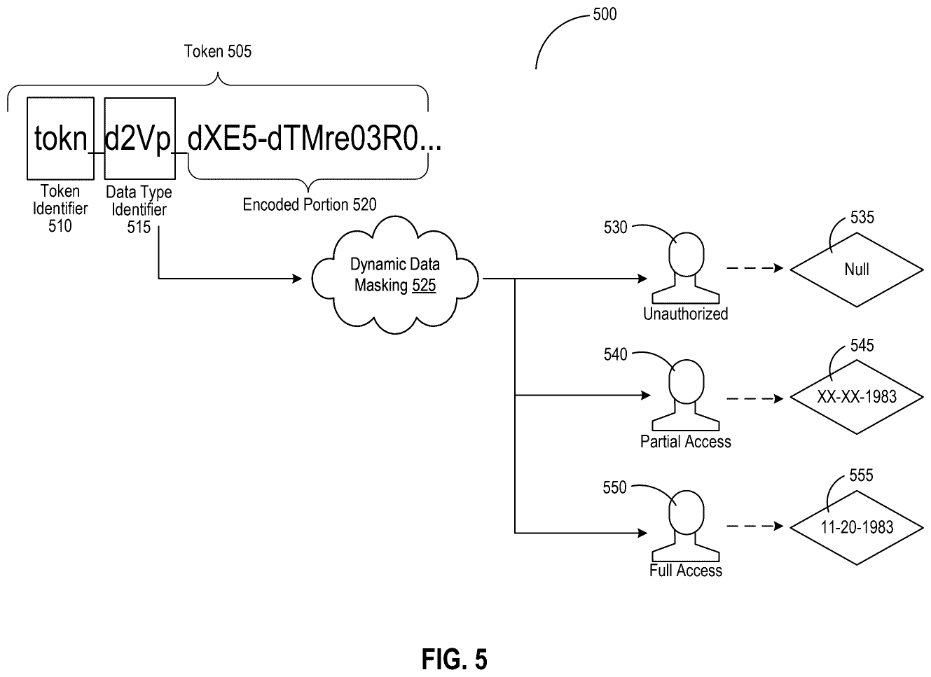

FIG. 5 illustrates a block diagram of a process 500 for controlling access on a user-basis in a vault-less tokenization system embodiments may include additional, fewer, or different operations from those described in the process 500. The process 500 may be performed by a server executing machine-readable software code, though it should be appreciated that the various operations may be performed by one or more computing devices and/or processors.

An encryption service may generate a token 505 to include a token identifier 510, a data type identifier 515, and an encoded portion 520, among others. The token 505 may be generated from an original value for an attribute type in an electronic document. The token identifier 510 may indicate that the token 505 is a token and not the original, unencrypted data of the electronic document. The data type identifier 515 may include the attribute type of the data that was encrypted in generating the token 505. The encoded portion 520 may correspond to the encrypted data generated from the original data in the electronic document using a public encryption key.

When the token 505 is received as part of a request to decode, the decryption service may perform dynamic data masking 525. The request may include the token 505 itself as well as an identifier of the user. Based on the user identifier, the decryption service may identify an access permission for the user. For an unauthorized user 530, the decryption service may return a null value of 535. For a user with partial access 540, the decryption service may generate and provide a portion of the original data 545 (e.g., a year of a date of birth). For a user with full access to 550, the decryption service may generate and provide an entirety of the data 555 (e.g., whole date of birth).

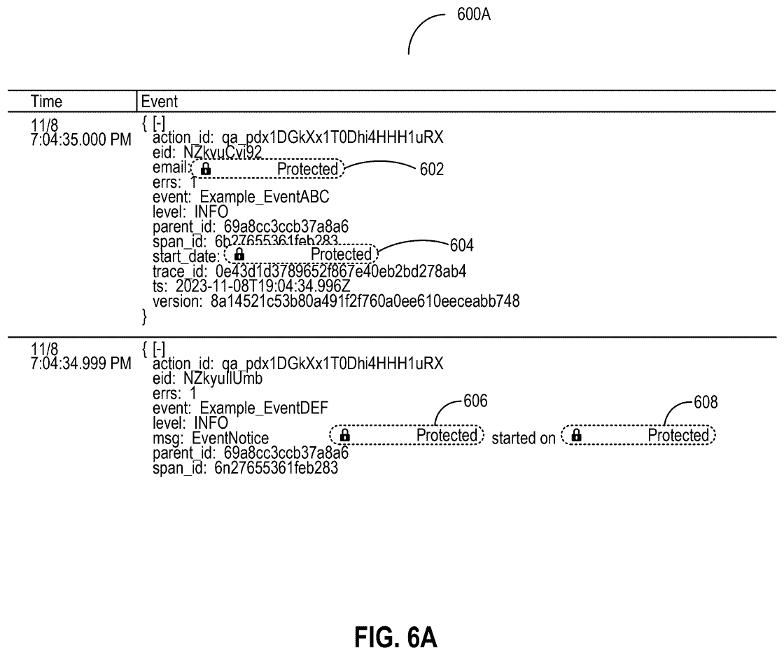

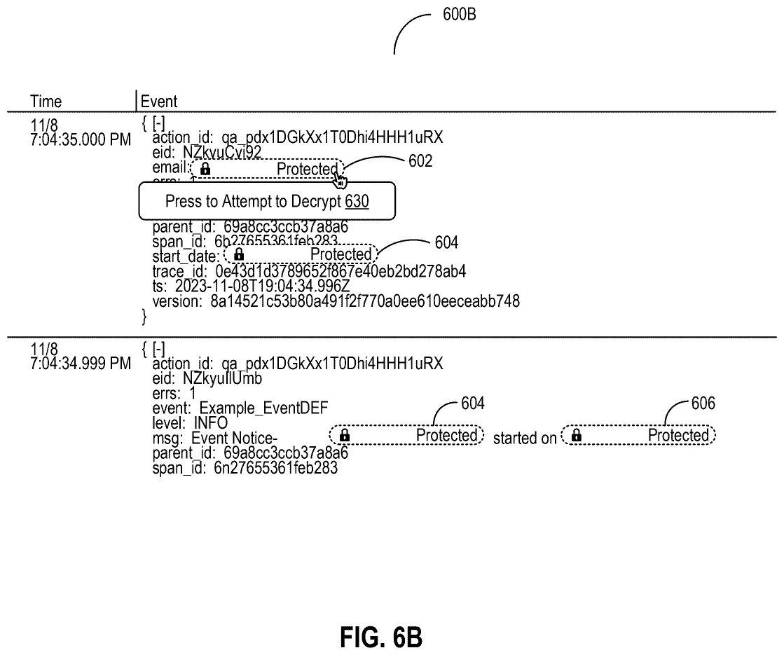

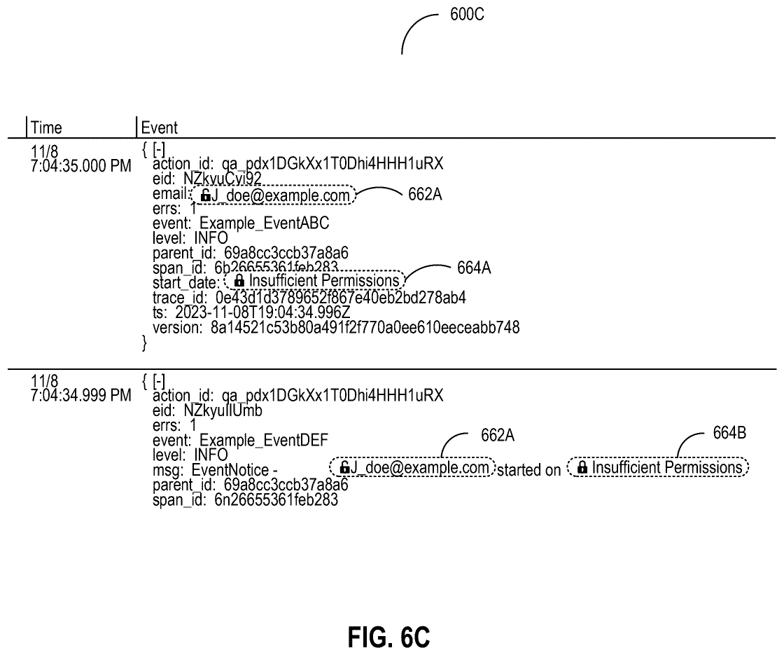

FIGS. 6A-C illustrate a set of screenshots of user interfaces 600A-C presenting an electronic document with protection over sensitive or confidential fields. Referring now to FIG. 6A, the user interface 600A may include an electronic document for logging. The electronic document may include one or more indicators 602-608 identifying data as protected. The data may be associated with attributes of field types that are determined to be sensitive or confidential. Moving onto FIG. 6B, the user may interact with one of the indicators 602, and the user interface 600B. When the cursor is hovering over the indicator 602, the user interface 600B may present a user interface clement 630 notifying the user to press to attempt to decrypt the protected data. Referring now to FIG. 6C, upon interacting with the indicator 602, the user interface 600C may present the results of the request to recover the original values. The user interface 600C may display two values 662A and 662B for which the user is determined to have access, and which is recovered from the underlying tokens. On the other hand, the user interface 600C may display two indicators, 664A and 664B, for which the user is determined to have insufficient permissions.

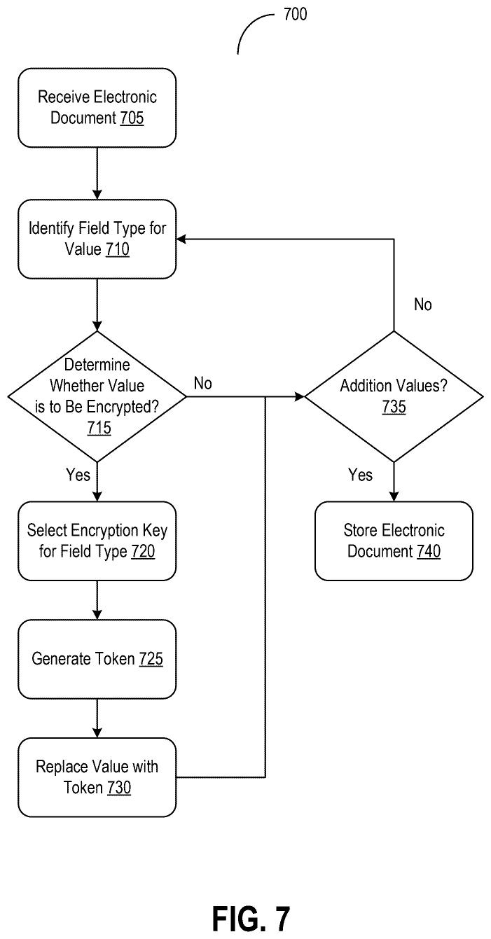

FIG. 7 illustrates a flow diagram of a method 700 of providing access to data in electronic documents. Embodiments may include additional, fewer, or different operations from those described in the method 700. The method 700 may be performed by a server executing machine-readable software code, though it should be appreciated that the various operations may be performed by one or more computing devices and/or processors. At step 705, an encryption service may receive an electronic document. The electronic document may include a set of values associated with a set of fields. Each field may be associated with a corresponding value. Each field may be defined by a field type. The value may include data for the given field type. At step 710, the encryption service may identify a field type of a field in the electronic document. At step 715, the encryption service may determine whether the value associated with the field type is to be encrypted. The determination may be based on whether the field type corresponds to sensitive or confidential information. If the field type corresponds to sensitive or confidential information, the encryption service may determine that the value associated with the field type is to be encrypted. Otherwise, if the field type does not correspond to sensitive or confidential information, the encryption service may determine that the value associated with the field type is to be not encrypted.

At step 720, if the determination is that the value is to be encrypted, the encryption service may select an encryption key for the field type associated with the value. The encryption key may be a part of a key pair generated and provided by a decryption service. For instance, the encryption key may be a public key generated in accordance with asymmetric encryption. Each encryption key may be associated by a particular field type. At step 725, the encryption service may generate a token using the original value and the encryption key. At step 730, the encryption service may replace the value with the token in the electronic document. At step 735, the encryption service may determine whether there are any additional values (or fields) to be evaluated in the electronic document. If there are additional fields, the encryption service may identify the field type for the next value and repeat the method 700 from step 710. Otherwise, at step 740, if there are no additional fields, the encryption service may store the electronic document on a database. By storing the electronic document in the database, the electronic document may become accessible to client devices.

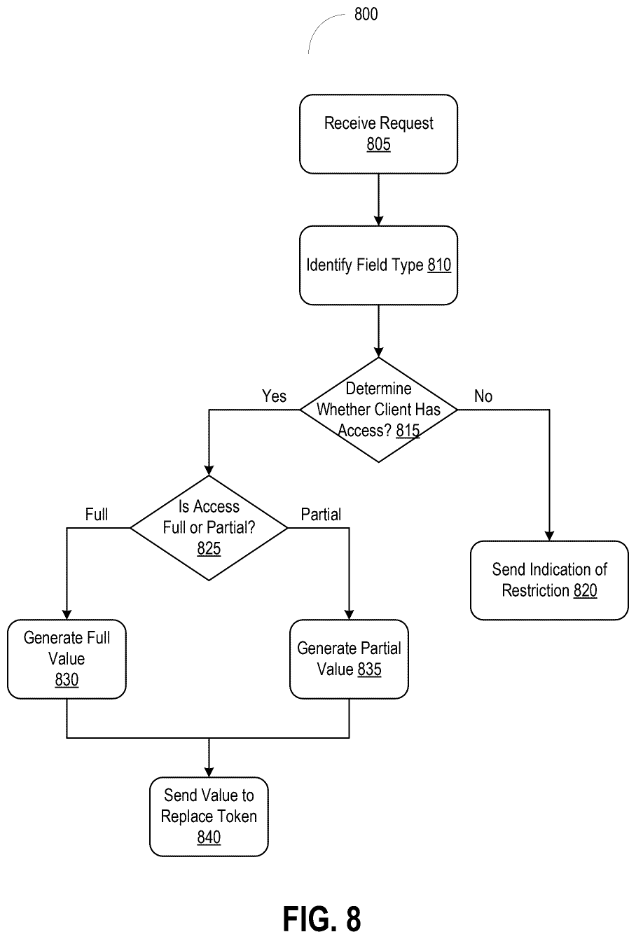

FIG. 8 illustrates a flow diagram of a method 800 of providing access to data in electronic documents. Embodiments may include additional, fewer, or different operations from those described in the method 800. The method 800 may be performed by a server executing machine-readable software code, though it should be appreciated that the various operations may be performed by one or more computing devices and/or processors. At step 805, a decryption service may receive a request to decrypt a token on an electronic document. The electronic document may include a set of values. The set of values may be associated with a corresponding set of fields. Each field may be associated with a corresponding value. Each field may be defined by a field type. The value may include data for the given field type. At least one of the original values on the electronic document may have been replaced with a token by an encryption service. The request may include the token associated with the original value and a user identifier. At step 810, the decryption service may identify a field type of the token from the request.

At step 815, the decryption service may determine whether the client device is permitted to access the original value for the field type. The determination may be based on the field type and the user identifier in accordance with an access policy for dynamic data masking. The access policy may specify which client devices have full or partial access to which field types. At step 820, when the access policy indicates that the client device has no access, the decryption service may send an indication of a restriction to the client device. At step 825, when the access policy indicates that the client device has some access, the decryption service may determine whether the access is to be full or partial. The determination may be in accordance with the access policy. At step 830, if the access is to be full, the decryption service may generate the full value using an encryption key. The encryption key may be part of a key pair, for which the other encryption key was provided to the encryption service. At step 835, if the access is to be partial, the decryption service may generate the partial value. The partial value may correspond to the full value generated using an encryption key, with modifications to hide a portion of the original value. At step 840, the decryption service may send the value (e.g., full or partial) to the client device.

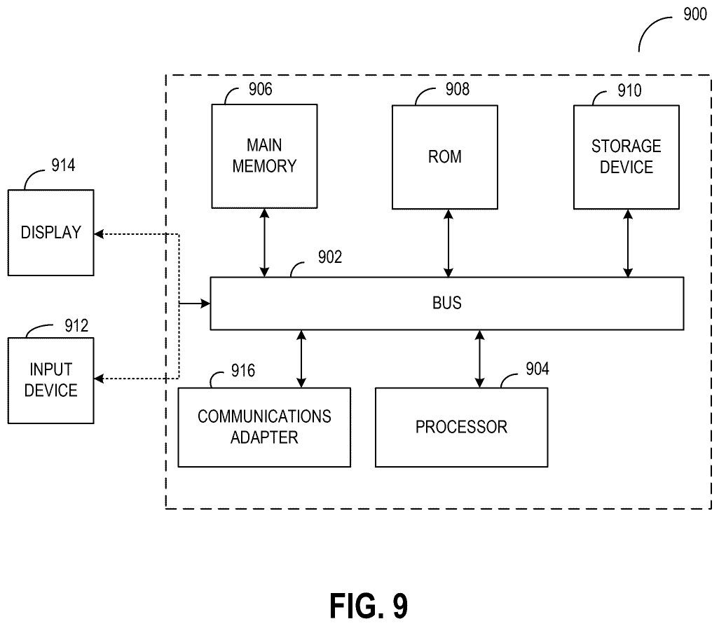

FIG. 9 is a component diagram of an example computing system suitable for use in the various implementations described herein, according to an example implementation. One or more steps of the methods and processes discussed herein can be performed by the computing system depicted in FIG. 9. The computing system 900 includes a bus 902 or other communication component for communicating information and a processor 904 coupled to the bus 902 for processing information. The computing system 900 also includes main memory 906, such as a RAM or other dynamic storage device, coupled to the bus 902 for storing information, and instructions to be executed by the processor 904. Main memory 906 can also be used for storing position information, temporary variables, or other intermediate information during the execution of instructions by the processor 904. The computing system 900 may further include a ROM 908 or other static storage device coupled to the bus 902 for storing static information and instructions for the processor 904. A storage device 910, such as a solid-state device, magnetic disk, or optical disk, is coupled to the bus 902 for persistently storing information and instructions.

The computing system 900 may be coupled via the bus 902 to a display 914, such as a liquid crystal display, or active-matrix display, for displaying information to a user. An input device 912, such as a keyboard including alphanumeric and other keys, may be coupled to the bus 902 for communicating information, and command selections to the processor 904. In another implementation, the input device 912 has a touchscreen display. The input device 912 can include any type of biometric sensor, or a cursor control, such as a mouse, a trackball, or cursor direction keys, for communicating direction information and command selections to the processor 904 and for controlling cursor movement on the display 914.

In some implementations, the computing system 900 may include a communications adapter 916, such as a networking adapter. Communications adapter 916 may be coupled to bus 902 and may be configured to enable communications with a computing or communications network or other computing systems. In various illustrative implementations, any type of networking configuration may be achieved using communications adapter 916, such as wired (e.g., via Ethernet), wireless (e.g., via Wi-Fi, Bluetooth), satellite (e.g., via GPS) pre-configured, ad-hoc, LAN, WAN, and the like.

According to various implementations, the processes of the illustrative implementations that are described herein can be achieved by the computing system 900 in response to the processor 904 executing an implementation of instructions contained in main memory 906. Such instructions can be read into main memory 906 from another computer-readable medium, such as the storage device 910. Execution of the implementation of instructions contained in main memory 906 causes the computing system 900 to perform the illustrative processes described herein. One or more processors in a multi-processing implementation may also be employed to execute the instructions contained in the main memory 906. In alternative implementations, hard-wired circuitry may be used in place of or in combination with software instructions to implement illustrative implementations. Thus, implementations are not limited to any specific combination of hardware circuitry and software.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of controlling access to values in electronic documents, comprising:
receiving, by a first service, an electronic document comprising a plurality of values associated with a corresponding plurality of fields to be provided to at least one of a plurality of client devices;
identifying, by the first service, from the electronic document, a field of the plurality of fields associated with a corresponding value of the plurality of values is to be encrypted;
maintaining, by the first service, on a database, a plurality of first encryption keys associated with a plurality of field types;
selecting, by the first service, from the plurality of first encryption keys, a first encryption key based on a field type of the field;
generating, by the first service, a token using the value and the first encryption key for the field, the first encryption key associated with a second encryption key on a second service to control access to the value; and
sending, by the first service to a client device of the plurality of client devices, the electronic document comprising the token replacing the value associated with the corresponding field, wherein the client device is configured to transmit a request comprising a user identifier and the token to the second service to determine whether to recover the value.

2. The method of claim 1, further comprising receiving, by the first service, from the second service, the plurality of first encryption keys associated with the plurality of field types to encrypt values in electronic documents.

3. The method of claim 1, further comprising:
identifying, by the first service, from the electronic document, a second field of the plurality of fields associated with a corresponding second value of the plurality of values is not to be encrypted; and
maintaining, by the first service, the corresponding second value associated with the second field in the electronic document.

4. The method of claim 1, further comprising removing, by the first service, storage of the token from the first service, responsive to sending the electronic document to the client device.

5. The method of claim 1, wherein identifying the field further comprises identifying the field as associated with sensitive information to be encrypted from the electronic document.

6. The method of claim 1, wherein generating the token further comprises generating the token to include: (i) a first portion identifying the first key used to generate the token and (ii) a second portion identifying the field type of the field associated with the value.

7. The method of claim 1, wherein sending the electronic document further comprises sending the electronic document to cause an application on the client device to display the electronic document including an indication of the value associated with the corresponding field as encrypted.

8. A method of providing access to values in electronic documents, comprising:
receiving, by a first service from a client device of a plurality of client devices, a request identifying (i) a user identifier associated with the client device and (ii) a token associated with a field of a plurality of fields of an electronic document, the token included by a second service into the electronic document using a first encryption key associated with a field type of a plurality of field types for the field;
identifying, by the first service, from the plurality of field types, the field type of the field based on at least a portion of the token;
determining, by the first service, that the client device is permitted to access a value associated with the token based on the user identifier and the field type in accordance with a policy, the policy identifying a respective permission for each of the plurality of client devices to access the plurality of field types;
generating, by the first service, the value using a second encryption key for the field type, the second encryption key associated with the first encryption key on the second service; and
sending, by the first service to the client device, the value to replace the token in the electronic document, wherein the client device is configured to present the electronic document with the token replacing the token.

9. The method of claim 8, further comprising:
determining, by the first service, that the client device is restricted from access to the value generated from the token based on the user identifier; and
sending, by the first service, to the client device, an indication that the value associated with the token is restricted from provision.

10. The method of claim 8, further comprising:
determining, by the first service, that the client device is permitted partial access to the value associated with the token based on the user identifier; and
sending, by the first service, a portion of the value to partially replace the token in the electronic document.

11. The method of claim 8, further comprising:
accessing, by the first service, a database to retrieve a plurality of second encryption keys associated with the plurality of field types to decrypt tokens in electronic documents; and
selecting, by the first service, from the plurality of second encryption keys, the second encryption key to generate the value based on the field type identified by the token.

12. The method of claim 8, further comprising:
generating, by the first service, a first plurality of encryption keys and a corresponding second plurality of encryption keys, for the plurality of field types in electronic documents; and
providing, by the first service, the second service access to the first plurality of keys for encrypting values of the corresponding plurality of field types in electronic documents.

13. The method of claim 8, wherein receiving the request further comprises receiving the request to recover the value, responsive to an application on the client device detecting an interaction with the token on the electronic document.

14. The method of claim 8, wherein sending the value further comprises sending the value to cause an application on the client device to (i) remove an indication of the value associated with the corresponding field as encrypted and (ii) display the value instead of the token on the electronic document.

15. A system for controlling access to values in electronic documents, comprising
a first service having one or more processors coupled with memory, configured to:
receive an electronic document comprising a corresponding plurality of values associated with a corresponding plurality of fields to be provided to at least one of a plurality of client devices;
identify, from the electronic document, a field of the plurality of fields associated with a corresponding value of the plurality of values is to be encrypted;
maintain, on a database, a plurality of first encryption keys associated with a plurality of field types;
select, from the plurality of first encryption keys, a first encryption key based on a field type of the field;
generate a token using the value and the first encryption key for the field, the first encryption key associated with a second encryption key on a second service to control access to the value; and
send, to a client device of the plurality of client devices, the electronic document comprising the token replacing the value associated with the corresponding field, wherein the client device is configured to transmit a request comprising a user identifier and the token to the second service to determine whether to recover the value.

16. The system of claim 15, wherein the first service is further configured to receive, from the second service, the plurality of first encryption keys associated with the plurality of field types to encrypt values in electronic documents.

17. The system of claim 15, wherein the first service is further configured to:
identify, from the electronic document, a second field of the plurality of fields associated with a corresponding second value of the plurality of values is not to be encrypted; and
maintain the corresponding second value associated with the second field in the electronic document.

18. The system of claim 15, wherein the first service is further configured to remove storage of the token from the first service, responsive to sending the electronic document to the client device.

19. The system of claim 15, wherein the first service is further configured to generate the token further comprises generating the token to include: (i) a first portion identifying the first key used to generate the token and (ii) a second portion identifying the field type of the field associated with the value.

20. The system of claim 15, wherein the first service is further configured to send the electronic document to cause an application on the client device to display the electronic document including an indication of the value associated with the corresponding field as encrypted.
